(19) United States
(12) Patent Application Publication
(10) Pub. No.: US 2020/0394711 A1
(43) Pub. Date: Dec. 17, 2020

(54) PREDICTING MARKET ACTIONS, DIRECTIONS OF ACTIONS AND ENGAGEMENT VIA BEHAVIORAL IQ ANALYSIS

(71) Applicant: Advisor Software, Inc., Walnut Creek, CA (US)

(72) Inventors: Andrew T. RUDD, Orinda, CA (US); Mark J. FERRARI, Berkeley, CA (US)

(73) Assignee: Advisor Software, Inc., Walnut Creek, CA (US)

(21) Appl. No.: 16/440,879

(22) Filed: Jun. 13, 2019

(51) Int. Cl. G06Q 40/04; G06N 3/08; G06N 3/04

(52) U.S. Cl. CPC G06Q 40/04; G06N 3/0454; G06N 3/08

(57) ABSTRACT

The disclosed technology teaches building a prediction classifier for individual subject trading behavior in response to a market event, utilizing questionnaire-based measures of ATR, confidence and optionally loss aversion. The method includes accessing observation data with questionnaire-based measures that score responses to questions in categories including ATR, loss aversion, confidence and demographic data, as predictor measures, and reported trading behavior that indicates degree of trading in response to the market event, for numerous subjects. The method also includes classifying the reported trading behavior in response to the market event by degree of hold/trade and buy/sell, including fitting a first classifier to distinguish between holding and trading, and fitting the second classifier, using the subjects classified as trading in response to the market event, as buying or selling. Parameters of the classifiers, after fitting, are stored, for two-stage production application to predict subject trading behavior in response to the market event.

### COPYRIGHT NOTICE

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Financial advisors work to assist their clients in managing their portfolios and investment strategies, with the goal of helping clients plan for life's circumstances, both expected and unexpected. Market events elicit a variety of responses from trading customers.

Historically, psychometric tests measure a client's subjective attitudes toward risk to determine a client's risk profile. These tests have enjoyed limited success, due to their subjectivity and the limitations in what the tests reveal.

A questionnaire that captures group attributes by behavioral categories can provide a level of summary insights into customer attitudes toward market conditions and events. However, even when insights are reduced to five to six parameters, it can be difficult to interpret, understand and operationalize the effects of attitudes on behaviors.

An opportunity arises to connect attitudes and behaviors and to operationalize predicted behaviors in view of current market conditions. The disclosed technology offers financial counselors a tool that utilizes the connections between attitudes and behaviors for counseling advisees, especially during notable market events. This disclosed technology advances the science of wealth planning so financial advisors can focus on the art of advice delivery. An increase in customer satisfaction and profits may result.

### SUMMARY

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of the summary is to present some concepts related to some exemplary non-limiting implementations in a simplified form as a prelude to the more detailed description of the various implementations that follow.

The disclosed technology teaches a method of building, fitting and using a prediction classifier for individual subject trading behavior in response to a past or future hypothetical market event, utilizing questionnaire-based measures of attitude towards risk (ATR) and confidence. The method includes accessing an observation set of data for numerous subjects with questionnaire-based measures and demographic data that includes gender, age, marital and family status, wealth and geographic location as predictor measures, and reported trading behavior that indicates degree of trading in response to the past or future hypothetical market event. The questionnaire-based measures score responses to questions in categories including ATR and confidence. The method includes classifying the reported trading behavior in response to the event by degree of hold/trade and buy/sell, fitting to distinguish between holding and trading in response to the event and training, using the subjects classified as trading in response to the event as buying or selling. The disclosed method also includes fitting a first classifier to distinguish between holding and trading in response to the past or future hypothetical market event, and fitting the second classifier to distinguish between buying and selling, using the subjects classified as trading in response to the past or future hypothetical market event. The method further includes storing parameters of the first and second classifiers after fitting, for two-stage production application to predict subject trading behavior in response to the past or future hypothetical market event.

An alert is generated for an advisor to predict trading behavior responsive to a past or future hypothetical market event, using the classifier after fitting, along with data for a subject that includes the questionnaire-based measures and demographic data as predictor measures. The classifier, after fitting, is applied to the input to predict trading behavior of the subject in response to the past or future hypothetical market event, distinguishing between holding and trading in response to the past or future hypothetical market event and for the subject classified as trading in response to the past or future hypothetical market event, distinguishing between buying and selling.

Other aspects and advantages of the technology disclosed can be seen on review of the drawings, the detailed description and the claims, which follow.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 depicts an exemplary system for building a prediction classifier for individual subject trading behavior in response to a past or future hypothetical market event, according to one implementation of the technology disclosed.

FIG. 2 shows an example set of data that includes questionnaire-based observation data and demographic data for twenty subjects, and predicted actions for a bear market event.

FIG. 3 shows a scatter plot of predicted actions that individual subjects would have taken in response to the financial crisis of 2008-2009.

FIG. 4 shows an example user interface screen for advisors for receiving alerts for specific investors.

FIG. 5 shows a risk attitude questionnaire section that identifies a customer's attitude toward risk taking as depending on what is at stake and what they want.

FIG. 6 shows a loss aversion section of a questionnaire that describes loss aversion to a survey taker.

FIG. 7 shows a questionnaire section for identifying a customer's confidence, defined as the difference between perception and reality, reveals how well balanced their confidence is, in ten questions.

FIG. 8 depicts a simplified block diagram of a computer system that can be used for building a prediction classifier for individual subject trading behavior in response to a past or future hypothetical market event, utilizing questionnaire-based measures of ATR, according to one implementation of the technology disclosed.

FIG. 9 shows an example single hidden layer fully connected neural network.

FIG. 10 builds on FIG. 9 by depicting multiple hidden layers with full connections.

FIG. 11 shows an example convolutional neural network architecture outline for building a constrained neural network to learn the relevant classification function for building a prediction classifier for individual subject trading behavior in response to a past or future hypothetical market event.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Risk investment advisors (RIAs), asset managers and brokers recommend investments to help customers reach their goals for college savings, retirement and wealth building. They recommend an allocation of assets consistent with the risk tolerance and life stage of clients. Financial advisors assist their customers in managing their financial portfolios and investment strategies, with the objective of helping the customers formulate effective plans and make timely responses to current market events to meet their financial goals.

Psychometric tests that measure a client's subjective attitudes toward risk can be used for determining a client's risk profile. While a questionnaire that groups attributes by behavioral categories can provide a level of summary insights into customer attitudes toward market conditions, even when the insights are reduced to just a few parameters that influence clients' thoughts on risk and decision-making, it can be difficult to interpret, understand and operationalize the effects of attitudes on behaviors in view of current market events. Modern deep learning machines are more able to digest complex data and to make inferences based on said data, including comprehensive questionnaire results that extend beyond psychometric testing to also measure the behavioral & contextual factors influencing risk and decision making of subjects.

Modern machine learning methods are general-purpose approaches to learn functional relationships from data without the need to define the relationships a priori. These methods can be utilized to leverage large data sets for finding hidden structure within them, and for making accurate predictions. Their appeal is the ability to derive a predictive model, also referred to as a classifier, without a need for strong assumptions about underlying mechanisms, which are frequently unknown or insufficiently defined. Machine learning and training of classifiers gives computers the ability to learn without being explicitly programmed, which involves fitting mathematical models using data and utilizing the resulting classifier in place of human written code. Two primary phases of building and using machine learning system are training and inference.

The disclosed technology offers financial counselors a tool that utilizes the connections between attitudes and behaviors, for counseling advisees. The technology teaches a system for predicting individual trading behavior, which includes fitting a classifier and generating predictions via inference. The disclosed system can be implemented in the context of various types of classifiers. We describe logistic binary classifiers and an alternative implementation that can utilize convolutional neural network (CNN) classifiers, next. Training of other classifiers is a natural extension of the techniques disclosed for the first two classifiers.

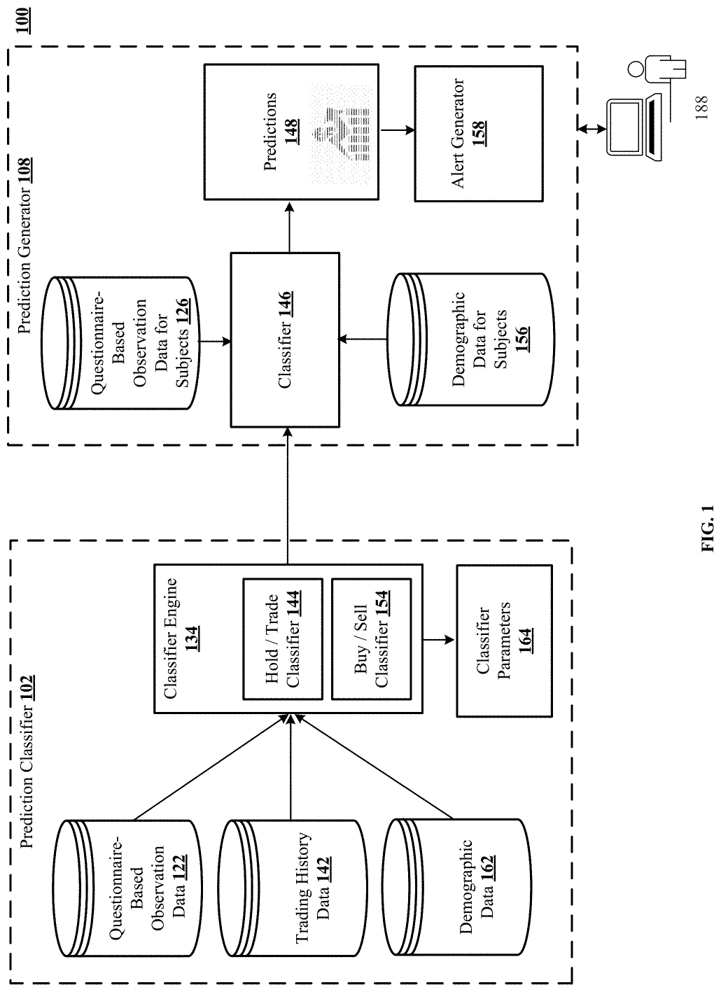

FIG. 1 shows a block diagram of system 100 for predicting individual subject trading behavior in response to a past or future hypothetical market event, utilizing questionnaire-based measures of attitude towards risk (ATR) and confidence, and in some implementations loss aversion. In one example, the questionnaire may include dozens of questions. System 100 includes prediction classifier 102 that utilizes questionnaire-based observation data 122, trading history data 142 and demographic data 162 as inputs to classifier engine 134 to generate classifier parameters 164 for fitting of classifier 146 in prediction generator 108. The trading history data 142 can be either self-reported or from trading logs, as further described below. This trading history data provides a ground truth for training. Classifier 146 can also be fit using data that reflects trades that never happened, either hypothetical, such as “What would you do if the market crashed?” or forecast by a third party, such as “Which of your clients are likely to panic in a crisis?” Classifier engine 134 includes hold/trade classifier 144 fitted to distinguish between holding and trading in response to the past or future hypothetical market event and buy/sell classifier 154 fitted, using the subject data classified as trading in response to the market event, as buying or selling.

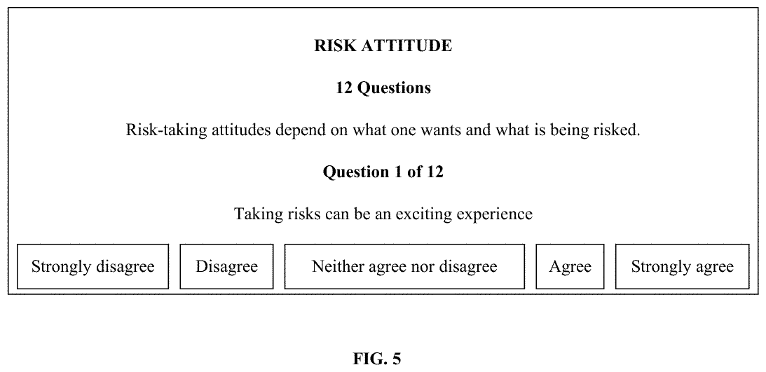

Continuing the description of system 100, the observation data sets include a combination of self-reported data, demographic data and data based on trading history. Self-reported data in questionnaire-based observation data 122 includes attitudinal summary data and behavioral data. The questionnaire and data are described in detail relative to FIG. 5 through FIG. 7 infra.

Continuing with the description of FIG. 1, system 100 includes trading history data 132 which stores reported trading behavior that indicates by degree of hold/trade and buy/sell, the degree of trading in response to the past or future hypothetical market event, with buy and sell data for individual subjects. In one case, reported trading behavior is self-reported by the subjects in response to a questionnaire. In another case, the reported trading behavior is actual trading data for clients in response to any past stressful situation, such as exuberant momentum following or fear of an impending crash. The recent winter 2016 and fourth quarter 2018 are examples of periods of market stress. The 2008 subprime meltdown is another example. System 100 also includes demographic data 152 that includes gender, age and wealth, and in some use cases, includes geographic data. In some implementations, demographic can also include marital status, whether the customer has children at home and self-reported income level. During fitting, classifier engine 134 utilizes observation data to connect attitudes and behaviors, using questionnaire-based observation data 122, trading history data 142 as classified reported trading behavior data which indicates the degree of trading in response to the past or future hypothetical market event, and demographic data 152.

Questionnaire-based observation data 122 includes responses to questions in categories including at least attitude towards risk and confidence. For the purpose of this discussion, attitude towards risk is a measure of the willingness to accept risk for a reward. Loss aversion measures the agony from a loss compared to the benefit felt by the subject from a gain of equal absolute magnitude—that is, sensitivity to loss regardless of gains when executing a series of buy and sell transactions. Confidence refers to the difference between subjective knowledge—that is, what the subject thinks they know, and objective knowledge, which is what the subject actually knows. The confidence score measures understanding perception vs true understanding of financial markets. In some use cases, these three behavioral measures can be supplemented by additional categories of behavioral metrics, including present bias which measures the preference of a subject for short versus long term rewards and decision approach which measures a subject's approach to investing, in a range from gut feel to detailed analysis. Some use cases include the behavioral categories of risk attitude that measures attitude towards risk based on what is at stake, and risk capacity that measures the maximum loss risked in a year for the possibility of a gain.

Continuing further with the description of FIG. 1, system 100 also includes prediction generator 108 which utilizes classifier 146 fitted with classifier parameters 164 generated by classifier engine 134 during fitting. Prediction generator 108 applies classifier 146 to data for subjects for whom attitudinal data is available but no actual behavioral data is available, generating an alert that predicts that the subject will respond to the past or future hypothetical market event by buying or selling. Questionnaire-based observation data for subjects 126 and demographic data for subjects 156 are inputs to classifier 146 that generates predictions 148 as inputs to alert generator 158 for alerting an advisor to predicted trading behavior responsive to a market event, for an individual subject. In some cases, predictions are generated for each of many individual subjects. System 100 also includes a user interface 188 for financial advisors for receiving the alerts that can be used by financial advisors to assist their customers to make timely responses to current market events to meet their financial goals.

In some use cases, questionnaire-based observation data for subjects 126 relies on fewer questions in the survey categories to produce category-aggregated scores, than the number of questions used for fitting classifier engine 134. That is, the survey administered to subjects to obtain questionnaire-based observation data 122 which is used for training classifier engine 134 may include two to three times as many questions per subject as the survey used in prediction generator 108. One implementation of the disclosed system includes validating a short questionnaire that aggregates to scores equivalent to long questionnaire aggregate scores.

The disclosed technology includes building prediction classifier 102 which utilizes questionnaire-based observation data 122 of ATR and confidence for fitting classifier engine 134 and prediction generator 108 and questionnaire-based observation data for subjects 126 for predicting individual subject trading behavior in response to a market event.

Different classifier types can be used to implement classifier engine 134. Logit is a statistical classifier model that uses logit regression for estimating the parameters of the logistic model, as described in “The Elements of Statistical Learning Data Mining, Inference, and Prediction” by Trevor Hastie, Robert Tibshirani and Jerome Friedman, on pages 119-124, and included herein by reference. In one example implementation, a logit model classifier is implemented in R, a software environment for statistical computing, to calculate linear combinations of behavioral insights questionnaire measures, for predicting a subject's trading behavior responsive to a past or future hypothetical market event. Fitting a logit model allows relevant explanatory variables to be distinguished from irrelevant ones, and model coefficients are readily interpreted as odds ratios. The disclosed technology includes classifier engine 134 with two classifiers: hold/trade classifier 144 and buy/sell classifier 154.

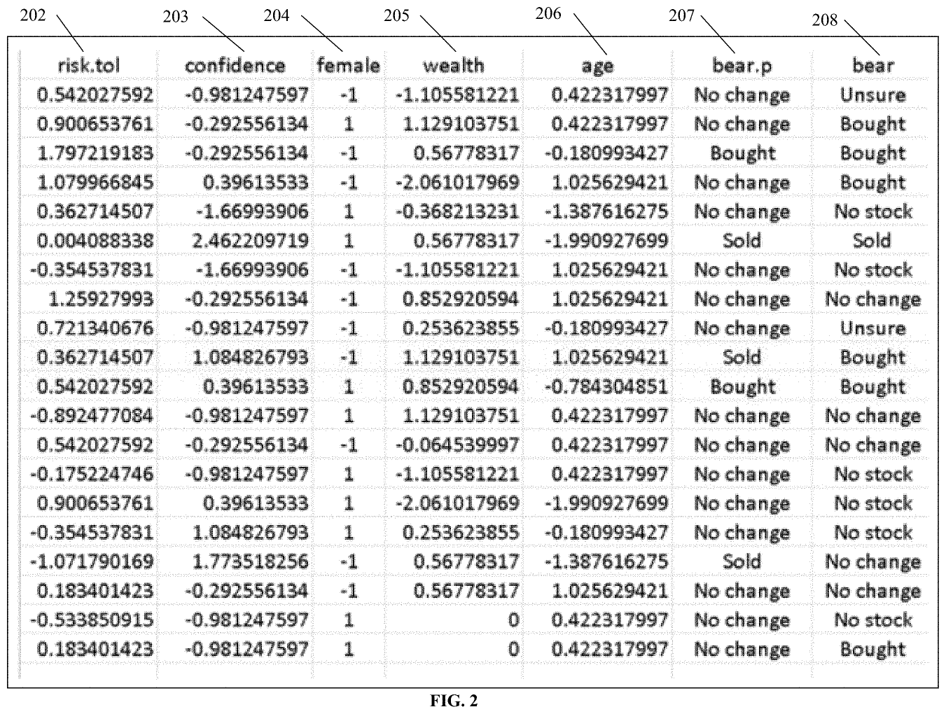

FIG. 2 shows an example set of data that includes questionnaire-based observation data 122 and demographic data 152 for twenty subjects, with one row of data per subject. In one use case, ten thousand samples are usable for fitting the classifiers. Columns of data represent variables used in calculating classifier predictions in one example: risk.tol 202, confidence 203, female 204, wealth 205, age 206. A code snippet in R, listed next, is usable for calculation of an action threshold variable above which action is predicted for the subject. Action.latent is calculated as −0.2×attitude toward risk +0.4×confidence −0.2×female +0.2×log.wealth −0.3×age in decades.

RS$action.latent <−0.2 * (RS$ATR_ScoreSD + 2 * RS$Conf_Score2SD −
RS$femaleSD + RS$log.wealthSD − 1.5 * RS$age.decadeSD)

Direction.latent, a direction threshold variable above which a buy action is predicted for the subject, is calculated as 0.8 ×attitude toward risk −0.5×confidence +0.5×log.wealth. The R code snippet for calculating the direction threshold is listed next.

RS$direction.latent <−0.8 * RS$ATR_ScoreSD − 0.5 * RS$Conf_Score2SD + 0.5 *
RS$log.wealthSD

Calculated action and direction threshold variables are usable in fitting a first classifier to distinguish between holding and trading, and fitting the second classifier, using the subjects classified as trading in response to the market event, as buying or selling in response to the market event.

For an advisor making predictions, a loss is associated with being wrong. The loss is much higher if a financial advisor predicts someone will not act when they do, and is also higher when an advisor fails to predict that someone will sell. Bias thresholds can be implemented to ensure that marginal actions are ignored; that is, classified as inactive even if they are not. The advisor can set the threshold for selling to be high so that more people are classified as sellers than buyers. Intervening when someone might panic sell is much more valuable than offering for them to buy when the market dips. Thresholds for action and direction are settable using user interface 188 for financial advisors. Then the classifier can compare the calculated values of action.latent and direction.latent to the set thresholds. The next R code snippet assigns values for the action and direction thresholds and shows the calculation of the bear.p prediction, based on the action.latent and direction.latent calculation results and the thresholds.

action.thr <−0.4
direction.thr <−0.5
RS$bear.p <− ifelse(RS$action.latent <= action.thr, “No change”,
ifelse(RS$direction.latent > direction.thr, “Bought”, “Sold”))

FIG. 2 also lists predicted behaviors in the column labelled bear.p 207 and actual behaviors in the column labelled bear 208. For example, two dependent variable values, which represent outcomes such as hold/trade and buy/sell, can be labelled as ‘0’ and ‘1’ and can be translated into words that represent the classifier results. Classifier engine 134 stores, in classifier parameters 164, the parameters of the first and second classifiers after fitting, for two-stage production application to predict subject trading behavior in response to the market event.

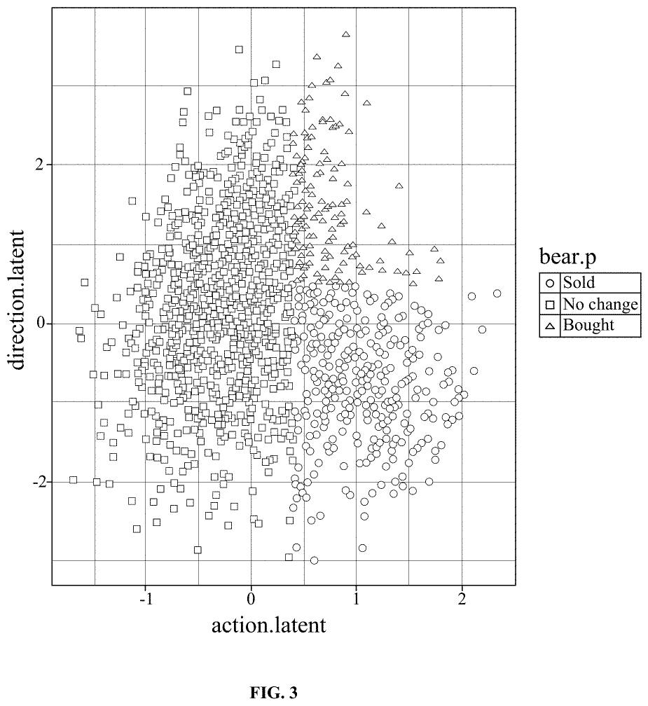

FIG. 3 shows a scatter plot of predicted actions that subjects would have taken in response to the financial crisis of 2008-2009, as a function of market direction. The x and y axes indicate the predicted propensity of the subjects to take action (x) 385 and the reported direction in which they are predicted to respond to the market event (y) 342. The axes are correlated with probability but are not expressed in units of probability. Two threshold parameters control the boundaries of the regions. Threshold parameter action.latent controls the right hand boundary of the region containing squares for which no change 336 is predicted, and parameter direction.latent controls the boundary between sold 326 represented by circles and bought 346 represented by triangles. That is, the scatter plot of FIG. 3 shows predictions for subjects' choice of action, with the three possible actions represented using circles to represent sold 326, squares to represent no change 336, and triangles to represent the action of bought 346. The three sets of data points effectively divide the plane into three areas, revealing a threshold above which subjects are predicted to make a different choice.

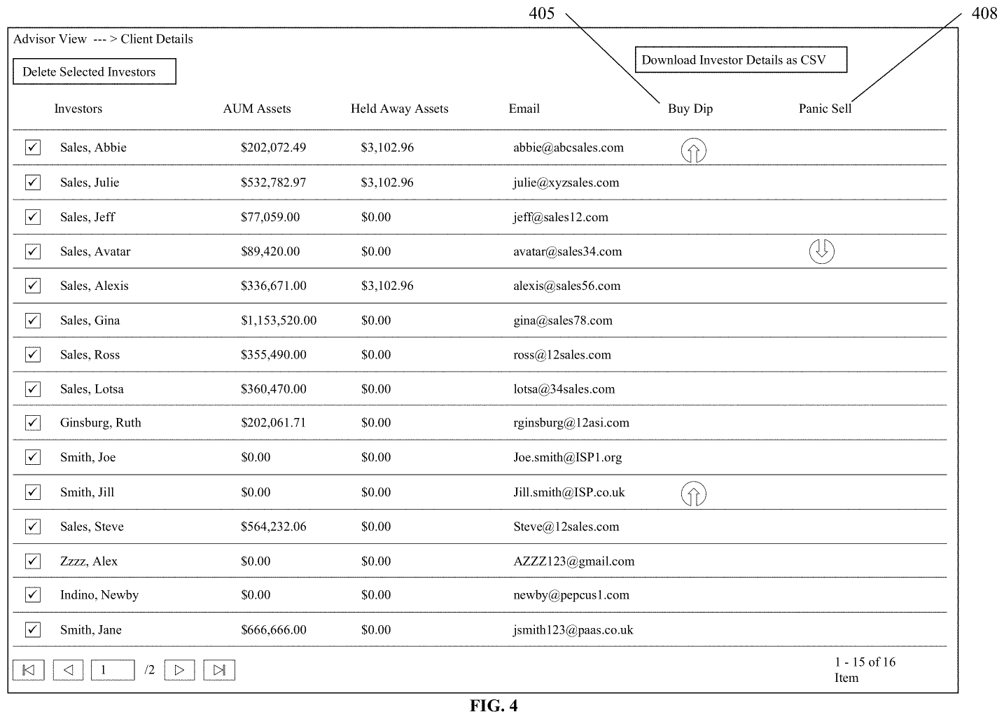

FIG. 4 shows an example user interface screen for advisors for receiving Buy Dip alerts 405 and Panic Sell alerts 408 that can be used by financial advisors to assist their customers to make timely responses to current market events to meet their financial goals. This behavioral coaching of a customer by an advisor can help investors understand how their behaviors can affect their financial future. For example, a financial advisor may prioritize contacting a panic-inclined client during a financial crisis. In one implementation additional information about a client can be offered, by classifying a combination of predictors. In one example, a prediction can be asserted that a customer is unsure of their best options, using predictive client risk profiling founded in behavioral science. In another implementation, a customer's attitudes can be combined with a financial advisor's comments on their interactions, to predict customer actions. Past behavior by a client can be used to verify self-reported behavior in another implementation. In another use case, a financial advisor may review prospective clients who have answered the questionnaire as a more likely candidate for services.

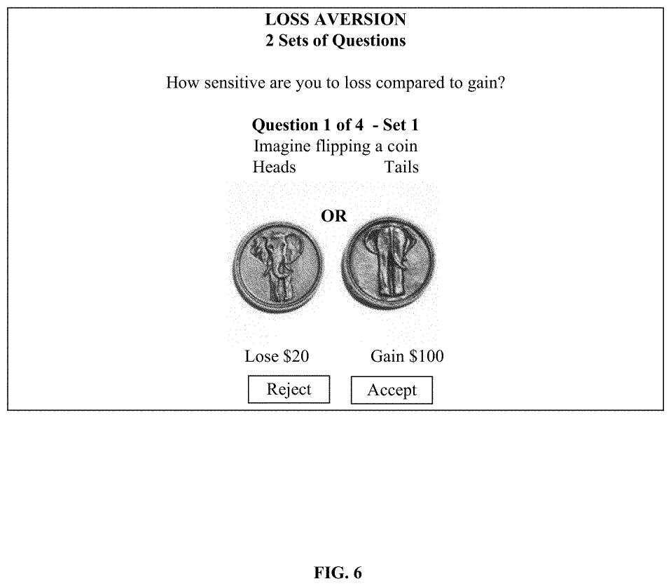

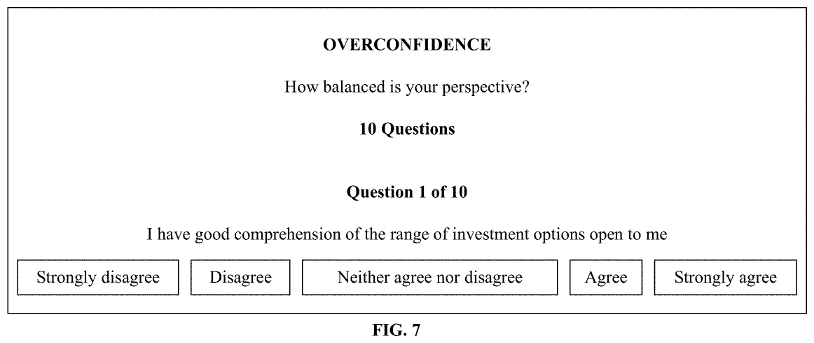

Self-reported data in questionnaire-based observation data 122 includes attitudinal summary data and behavioral data, as mentioned supra. Subjects complete a behavioral insights questionnaire that enables the discovery of exhibited behavioral profiles and that enables the capture of attitudes and behavioral profiles of individuals. The survey results reflect biases prevalent in the behavior of the subjects that may cause them to hold inefficient portfolios and pursue sub-optimal investment strategies. Questionnaire-based measures score responses to questions in the survey in categories of behavioral metrics that include at least attitude towards risk, confidence and loss aversion. In one use case, questionnaire-based measures aggregate responses to questions into categories. In another use case, the questionnaire-based measures express responses to individual questions. One example questionnaire is offered by Be-IQ (Behavioural Insights, formerly Suitable Strategies (copyright) https://www.beiq.co.uk/, which provides aggregated scoring of subjects' responses into behavioural categories. Three of the behavioural categories that are used by Be-IQ to produce aggregate measures are implemented in series of questions about attitude towards risk, loss aversion and confidence in choosing an investment strategy. These categories of questions may, for instance, be two to twenty questions. The details of Be-IQ methodology are available directly from the company. The data is accurate to the extent that humans self-report their actions accurately. Examples of category introductions and lead in questions appear in FIG. 5, FIG. 6 and FIG. 7.

FIG. 5 shows a risk attitude questionnaire section that identifies a customer's attitude toward risk taking as depending on what is at stake and what they want. An example first question asks the survey taker to determine to what level they agree with the statement, “Taking risks can be an exciting experience.”

FIG. 6 shows a loss aversion section of a questionnaire that describes loss aversion to a survey taker: “How sensitive are you to loss compared to gain?” The section includes two sets of questions. The first question asks the customer to imagine flipping a coin and then to accept or reject the odds of losing twenty dollars if the coin lands on heads, or to gain one hundred dollars if the coin lands on tails. A series of this type of question are used to analyze a customer's attitudes relative to loss aversion.

FIG. 7 shows a questionnaire section that identifies a customer's overconfidence, defined as the difference between perception and relative reveals how well balanced their perspective is, in ten questions. An example first question asks the survey taker to react to the statement, “I have good comprehension of the range of investment options open to me,” by selecting strongly agree, agree, neither, disagree, or strongly disagree. Additional questionnaire sections can include a customer's approach to making money-related decisions.

Other sources of questionnaires that could alternatively be used include the surveys offered by individual companies. The overall approach builds on questionnaire research such as for computerized adaptive testing (CAT), a form of computer-based test that adapts to the examinee's ability level. The next item or set of items selected to be administered depends on the test taker's responses to the most recent items administered. In one implementation, the questionnaire can begin with a middle-of-the-road question and adapt the order of questions based on responses from the survey taker. In one case, questionnaire-based measures are collected using an adaptive questionnaire that selects questions to pose, after one or more opening questions in a category, based at least in part on responses to previous questions in the category. In one example, in assessing risk tolerance, if the response to a first question indicates risk seeking behavior, the second question can be “What fraction of your portfolio is in foreign stocks?”; otherwise the second question can ask about fixed income.

Other example classifiers applied to predicting individual trading behavior in response to a past or future hypothetical market event are a neural network (NN) and a convolutional neural network (CNN). These classifiers accept as inputs category-aggregated scores, responses to individual questions, or both. Logistic and CNN classifiers can be combined or run in parallel.

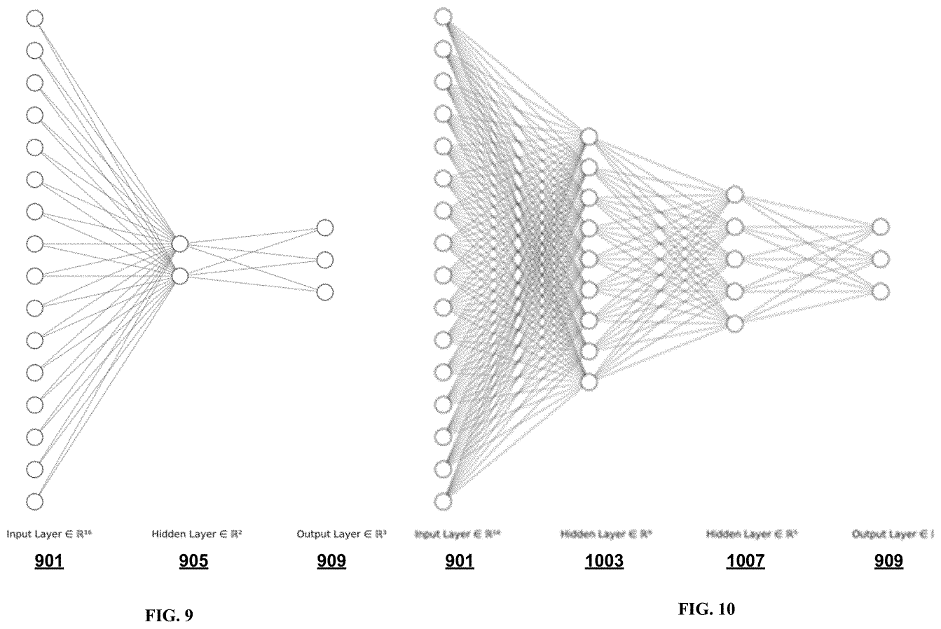

Other classifiers that can be applied to aggregate category scores, responses to individual questions, or both include fully connected neural networks, k-nearest neighbor (KNN) classifiers, support vector machines and random forest classifiers. With instructions on how to apply logistic binary classifiers and CNNs to the proposed inputs to produce the desired outputs, one of skill in the art will be well-guided in making these other classifiers usable. . . . Both NNs and CNNs can be trained to make predictions directly from answers to questions. A NN uses one or more fully connected layers to generate one or more outputs. The CNN uses one or more convolutional layers, typically followed by at least one fully connected layer and/or a softmax layer to generate one or more outputs. Examples of NNs and CNNs are shown in FIGS. 9-11. Training is similar for each form of network, using aggregate category scores, responses to individual questions, or both as predictors, akin to independent variables, and using trading data, which may be scored or categorized, as ground truth of individual behavior under market stress. The trading data can be expressed as a scored propensity to buy, hold or trade, or by applying a categorical label, either self-reported or derived from actual trading during periods of market stress. Training examples pair survey responses with trading data.

FIG. 9 shows an example single hidden layer fully connected NN. An input layer 901 accepts a number of inputs corresponding to answers to questions, to aggregate category scores, or both. The number of questions and categories is readily adapted to a questionnaire. In one implementation, different numbers of questions can be used to represent a constant number of categories, in a short and a long questionnaire. Or, a subset of questions from the long questionnaire can be used in the short questionnaire, following the outline above. A hidden layer 905 is fully connected to input nodes of the input layer 901. The hidden layer 905 has two units, corresponding to our latent action and latent direction submodels, and their activation functions are sigmoid. The output layer 909 can use a softmax activation, a rectified linear unit (ReLU), leaky or not, or another of activation function. As depicted, output layer 909 can include three units that are trained to behavior classified as sell risky assets (S), buy more risk (B), or do nothing (X), respectively. Training this network has the potential to rediscover our logit classifier or to find a superior weighting scheme. Either result has practical benefits.

While the figure depicts two hidden layer nodes, a larger number of hidden layer nodes can be used, such as a number corresponding to or within a range of the number of categories believed to describe behavior in response to market stress. For aggregate categories such as at least attitude towards risk, confidence and loss aversion, a hidden layer could have three nodes, in one implementation. The output layer 909 can be fully connected to the hidden layer 905; it can apply a sigmoid activation function to the hidden layer or another activation function as described above. In some implementations, the number of output nodes corresponds to categories in the training data. For training data from which extracted features upon encountering market stress include buy, hold, sell some, and panic sell, the number of output nodes could be one or four, corresponding to a buy/sell propensity continuum or a probability of an individual investor behaving as typical of the categorical labels. If three labels, buy, hold or sell apply, there may be three output nodes as depicted. When a propensity score is output during inference, a simple-threshold based classifier can be used to translate the propensity score into a categorical label.

During training, coefficients are calculated that connect layers. In FIG. 9, either one or two layers of coefficients can be trained, depending on design of the output layer. NNs can encode nonlinearities and interactions. Complex interactions are easily captured by including more hidden layers and more units in each layer, as in the following figure.

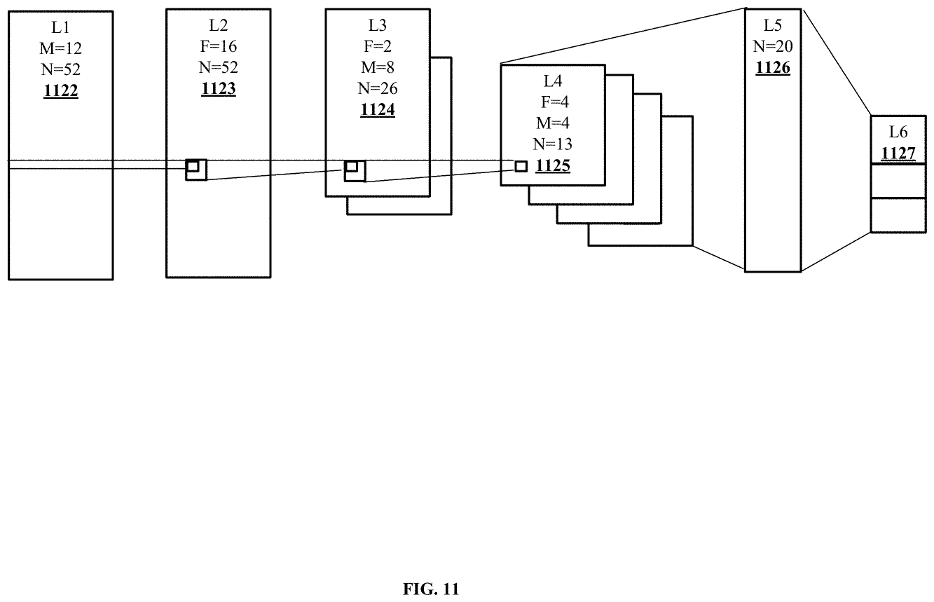

FIG. 10 builds on FIG. 9 by depicting multiple hidden layers 1003, 1007 with full connections. It takes more training data to train coefficients for more layers. In general, the number of nodes should decrease or remain constant in successive layers of a NN that has multiple hidden layers, especially when a small number of output nodes are used to predict an investor's behavior.

FIG. 11 shows an example CNN architecture outline for predicting individual trading behavior in response to a past or future hypothetical market event. The number of layers and filters and the size of receptive fields can be refined using an automated hyper-parameter search, available for many deep learning frameworks. CNN classifier can accept as input answers to individual questions, category aggregate scores, or both. Input layer L1 1122 can be one hot encoded. In this example, N=52 questions are depicted as rows of input (or alternatively, as columns), which corresponding to a behavioral and demographic survey with that many questions. In the example, M=12 columns (or alternatively, as rows) of the input matrix corresponds to the maximum number of choices to be encoded for any survey question. Only a selected answer generates a one hot encoding, so some questions will have zeros in some or most of the columns, such as yes/no questions having just two possible values to encode. An alternative to one hot encoding is categorical encoding, typically with integer values, of answers to questions. A mixture of one hot and categorical encoding can be applied.

Scoring layer L2 1123 is a feature map whose rows correspond to questions and columns to filters that implement alternative scoring methods. Again, rows and columns can be transposed. The example applies F=16 different filters to each question. When responses begin from a normalized response format, such as a scale of 1 to 5, the number of filters can be less than when the number of responses varies among questions. Similarly, if category aggregated scores are taken as input the number of filters can be fewer than the number required for unnormalized inputs. The higher the number of filters, the more training data required to train the filters from random starting seeds. Each unit in L2 1123 has a receptive field corresponding to all answers, with width=12, to one question, so height=1. The filter function is computed from the number of possible answers plus one bias value. In this configuration, the same filters are applied to all questions.

In an alternative configuration, input layer L1 and scoring layer L2 can be organized into lanes by category, so that filters are trained on questions within a category. This may make it easier to normalize answers to the questions. Lanes can extend to L3 and filters can apply across questions in a category. Filters need not be the same size; with n one or more layers, intermediate features can be computed corresponding to a number of aggregate categories.

In the example shown, network layer L3 1124 and layer L4 1125 employ 2×2 receptive fields and a stride of two to reduce the number of units in each filter plane to one-quarter of the previous layer. L3 1124 implements F=2 filters and L4 1125 implements F=4, with five parameters in L3 1124 and nine in L4 1125. Larger receptive filters reduce one dimension of layer output. More filters increase another dimension of layer output. In CNNs, receptive fields of 2×2, 3×3, up to 7×7 can be used. For one hot encoded survey responses, the receptive fields can be rectangular instead of square, for instance following the survey approach of aggregating “top two” choices in a cross-tab table.

The final hidden layer, L5 1126 in this example, contains units fully connected to L4 1125. This example depicts twenty units. Ten to forty units could be used or another unit count selected by a hyper-parameter search. Output layer L6 1127 is fully connected to L5 1126 with a softmax activation function. For the example CNN architecture described, a given piece of information appears in the same place in the input layer each time. That is, the first row of L1 1122 corresponds to the same question for all respondents, so pooling layers are not needed to detect a feature whose location is uncertain.

The order of assignment of questions to the rows of L1 1122 affects the combinations and interactions that the network is predisposed to discover. The order of rows can be designed as an input condition or a permutation layer can be added to allow the network to optimize the order, in an alternative architecture. Also, answers that are equivalent across questions, such as “unknown” or “decline to state”, can be set up to appear in the same column of L1 1122 so the scoring layer can find them efficiently.

Another modification to the architecture can be the addition of an input column indicating whether the respondent has chosen the correct answer to a question that has a correct answer.

Research indicates that some characteristics such as gender and wealth have a disproportionate effect on observed outcomes, so another architecture option that distinguishes behavioral from demographic inputs can utilize a skip architecture in which some inputs are connected directly to deeper hidden layers, giving a combination of linear response as skipped, plus perturbations that are convolutional.

Next, we describe a computer system for building a prediction classifier for individual subject trading behavior in response to a past or future hypothetical market event.

### Computer System

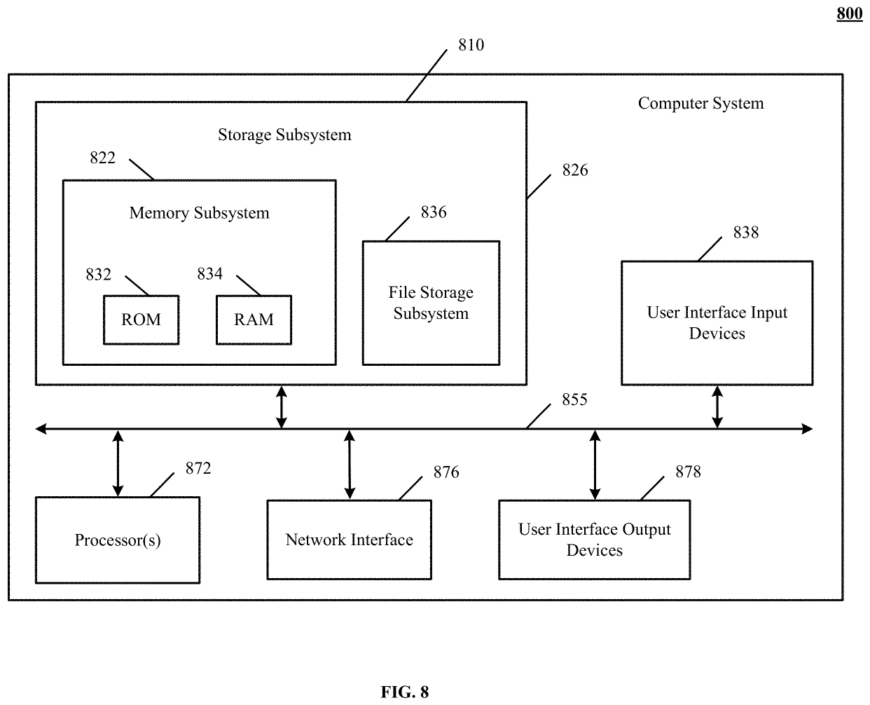

FIG. 8 is a simplified block diagram of a computer system 800 that can be used for building a prediction classifier for individual subject trading behavior in response to a past or future hypothetical market event, utilizing questionnaire-based measures of ATR and confidence, according to one implementation of the technology disclosed.

Computer system 800 includes at least one central processing unit (CPU) 872 that communicates with a number of peripheral devices via bus subsystem 855. These peripheral devices can include a storage subsystem 810 including, for example, memory devices and a file storage subsystem 836, user interface input devices 838, user interface output devices 878, and a network interface subsystem 874. The input and output devices allow user interaction with computer system 800. Network interface subsystem 876 provides an interface to outside networks, including an interface to corresponding interface devices in other computer systems.

In one implementation, user interface input devices 838 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 800.

User interface output devices 876 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 800 to the user or to another machine or computer system.

Storage subsystem 810 stores programming and data constructs that provide the functionality of some or all of the modules and methods described herein. These software modules are generally executed by processors 872.

Memory subsystem 822 used in the storage subsystem 810 can include a number of memories including a main random access memory (RAM) 832 for storage of instructions and data during program execution and a read only memory (ROM) 834 in which fixed instructions are stored. A file storage subsystem 836 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 836 in the storage subsystem 810, or in other machines accessible by the processor.

Bus subsystem 855 provides a mechanism for letting the various components and subsystems of computer system 800 communicate with each other as intended. Although bus subsystem 855 is shown schematically as a single bus, alternative implementations of the bus subsystem can use multiple busses.

Computer system 800 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 800 depicted in FIG. 8 is intended only as a specific example for purposes of illustrating the preferred embodiments of the present invention. Many other configurations of computer system 800 are possible having more or fewer components than the computer system depicted in FIG. 8.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

### Some Particular Implementations

Some particular implementations and features are described in the following paragraphs.

One implementation of the disclosed method of building a prediction classifier for individual subject trading behavior in response to a past or future hypothetical market event, utilizing questionnaire-based measures of ATR and confidence includes accessing an observation set of data for numerous subjects. The observation set of data includes, for the subjects, questionnaire-based measures wherein the questionnaire-based measures score responses to questions in categories including at least ATR and confidence and demographic data that includes at least gender, age and wealth as predictor measures, and reported trading behavior that indicates degree of trading in response to the past or future hypothetical market event. The method also includes classifying the reported trading behavior in response to the past or future hypothetical market event by degree of hold/trade and by degree of buy/sell, fitting one or more classifiers using at least the questionnaire-based measures, the demographic data and the classified reported trading behavior. The classifying includes fitting a first classifier to distinguish between holding and trading in response to the past or future hypothetical market event and fitting the second classifier, using the subjects classified as trading in response to the past or future hypothetical market event, as buying or selling. The method further includes storing on non-transitory memory parameters of the first and second classifiers after fitting, for two-stage production application to predict subject trading behavior in response to the past or future hypothetical market event.

This architecture and other implementations of the technology disclosed can include one or more of the following features and/or features described in connection with additional architectures disclosed. In the interest of conciseness, the combinations of features disclosed in this application are not individually enumerated and are not repeated with each base set of features.

For one implementation of the disclosed method, the first classifier and the second classifier are a pair of logistic binary classifiers working on aggregate category scores.

For another implementation of the disclosed method, the first classifier and the second classifier are convolutional neural network (abbreviated CNN) classifiers. These classifiers can be applied to aggregate category scores, responses to individual questions, or both. Logistic and CNN classifiers can be combined.

Other classifiers that can be applied to aggregate category scores, responses to individual questions, or both include fully connected neural networks, k-nearest neighbor (KNN) classifiers, support vector machines and random forest classifiers. With instructions on how to apply logistic binary classifiers and CNNs to the proposed inputs to produce the desired outputs, one of skill in the art will be well-guided in making these other classifiers usable.

In some implementations of the disclosed method, the reported trading behavior is self-reported by the subjects in response to a questionnaire. In other implementations, the reported trading behavior is trading data. In one implementation, trading data reflects trades that never happened, either hypothetical, such as “What would you do if the market crashed?” or forecast by a third party, such as “Which of your clients are likely to panic in a crisis?”

For one implementation of the disclosed method, the questionnaire-based measures aggregate responses to questions in the categories. In other implementations, the questionnaire-based measures express responses to individual questions.

For some implementations of the disclosed method, the questionnaire-based measures are collected using an adaptive questionnaire that selects questions to pose, after one or more opening questions in a category, based at least in part on responses to previous questions in the category.

In one implementation, the demographic data further includes geography as zip code. In some implementations, attitude towards risk is a measure of the willingness to accept risk for a reward. In some implementations, the questionnaire-based measures further include loss aversion. Loss aversion is a measure of the trade-off of the upside to the downside—agony from a loss compared to the benefit felt by the subject from a gain of equal absolute magnitude—sensitivity to loss regardless of gains when participating in a series of trading events. Confidence is a measure of the difference between subjective knowledge—what the subject thinks they know, and objective knowledge, which is what the subject actually knows; understanding perception vs true understanding of the financial markets.

One implementation of the disclosed technology includes a method of alerting an advisor to predicted trading behavior of a subject responsive to a past or future hypothetical market event, including inputting, to at least one classifier after fitting, data for the subject: questionnaire-based measures and demographic data as predictor measures. The questionnaire-based measures score responses to questions in categories including at least attitude towards risk and confidence and the demographic data includes at least gender, age and wealth. The disclosed method includes applying the classifier, after fitting, to the input to predict trading behavior of the subject in response to the past or future hypothetical market event, including classifying the subject as trading, as opposed to holding, in response to the past or future hypothetical market event and distinguishing, for the subject classified as trading in response to the past or future hypothetical market event, between buying or selling. The disclosed method further includes generating an alert that predicts that the subject will respond to the past or future hypothetical market event by buying or selling.

For some implementations of the disclosed method, questionnaire-based measures score aggregated responses to multiple questions in the categories and the questionnaire-based measures rely on fewer questions in the categories, to produce category-aggregated scores, than used for fitting the classifier.

For other implementations of the disclosed method, the questionnaire-based measures score aggregates of the questions in the categories, with the questionnaire-based measures and demographic data are combined as weighted sums. The disclosed method further includes the classifier, after fitting, applying thresholds to the weighted sums to accomplish the distinguishing between holding and trading and the distinguishing between buying and selling. In some disclosed methods, the questionnaire-based measures score individual questions in the categories, inputting the questionnaire-based measures and demographic data to one or more convolutional neural network (abbreviated CNN) classifiers; and further include the CNN classifiers outputting data to a layer that classifies the subject as holding or trading, and further classifies the trading subject as buying or selling. Some disclosed methods also include using an ensemble of CNN classifiers with separate CNNs organized to process respective categories of the questionnaire-based measures. These methods also include the separate CNNs outputting data to the layer that classifies the subject as buy, sell or hold.

The technology disclosed can be practiced as a system, method, or article of manufacture. One or more features of an implementation can be combined with the base implementation. Implementations that are not mutually exclusive are taught to be combinable. One or more features of an implementation can be combined with other implementations.

In another implementation, a disclosed system includes one or more processors coupled to memory, the memory loaded with computer instructions, when executed on the processors, implement actions of the disclosed method described supra.

In yet another implementation a disclosed tangible non-transitory computer readable storage media impressed with computer program instructions that, when executed on a processor, cause hardware to implement the disclosed methods and architectures described supra.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

We claim as follows:

1. A tangible non-transitory computer readable storage media impressed with computer program instructions that, when executed on a processor, cause the processor to implement a method of building a prediction classifier for individual subject trading behavior in response to a past or future hypothetical market event, utilizing questionnaire-based measures of attitude towards risk (abbreviated ATR) and confidence, the method including:
accessing an observation set of data for numerous subjects including, for the subjects:
questionnaire-based measures and demographic data as predictor measures, and
reported trading behavior in response to the market event as a result;
wherein the questionnaire-based measures score responses to questions in categories including at least ATR and confidence;
wherein the reported trading behavior indicates degree of trading in response to the market event;
wherein the demographic data includes at least gender, age and wealth;
classifying the reported trading behavior in response to the market event by degree of hold/trade and by degree of buy/sell;
fitting one or more classifiers using at least the questionnaire-based measures, the demographic data and the classified reported trading behavior, including:
fitting a first classifier to distinguish between holding and trading in response to the market event; and
fitting a second classifier, using the subjects classified as trading in response to the market event, as buying or selling; and
storing on non-transitory memory parameters of the first and second classifiers after fitting, for two-stage production application to predict subject trading behavior in response to the market event.

2. The tangible non-transitory computer readable storage media of claim 1, wherein the first classifier and the second classifier are a pair of logistic binary classifiers working on aggregate category scores.

3. The tangible non-transitory computer readable storage media of claim 1, wherein the first classifier and the second classifier are an ensemble of convolutional neural network (abbreviated CNN) classifiers in layers working on individual questions.

4. The tangible non-transitory computer readable storage media of claim 1, wherein the reported trading behavior is self-reported by the subjects in response to a questionnaire.

5. The tangible non-transitory computer readable storage media of claim 1, wherein the reported trading behavior is trading data.

6. The tangible non-transitory computer readable storage media of claim 1, wherein the questionnaire-based measures aggregate responses to questions in the categories.

7. The tangible non-transitory computer readable storage media of claim 1, further including utilizing questionnaire-based measures of loss aversion.

8. The tangible non-transitory computer readable storage media of claim 1, wherein the questionnaire-based measures express responses to individual questions.

9. The tangible non-transitory computer readable storage media of claim 1, wherein the questionnaire-based measures are collected using an adaptive questionnaire that selects questions to pose, after one or more opening questions in a category, based at least in part on responses to previous questions in the category.

10. A tangible non-transitory computer readable storage media impressed with computer program instructions that, when executed on a processor, cause the processor to implement a method of alerting an advisor to predicted trading behavior of a subject responsive to a past or future hypothetical market event, the method including:
inputting, to at least one classifier after fitting, data for the subject including:
questionnaire-based measures and demographic data as predictor measures;
wherein the questionnaire-based measures score responses to questions in categories including at least attitude towards risk and confidence;
wherein the demographic data includes at least gender, age and wealth;
applying the classifier, after fitting, to the input to predict trading behavior of the subject in response to the market event, including:
classifying the subject as trading, as opposed to holding, in response to the market event; and
distinguishing, for the subject classified as trading in response to the market event, between buying or selling; and
generating an alert that predicts that the subject will respond to the market event by buying or selling.

11. The tangible non-transitory computer readable storage media of claim 10, wherein questionnaire-based measures score aggregated responses to multiple questions in the categories and the questionnaire-based measures rely on fewer questions in the categories, to produce category-aggregated scores, than used for fitting the classifier.

12. The tangible non-transitory computer readable storage media of claim 10, wherein the demographic data further includes geography as a zip code.

13. The tangible non-transitory computer readable storage media of claim 10,
wherein:
the questionnaire-based measures score aggregates of the questions in the categories;
the questionnaire-based measures and demographic data are combined as weighted sums; and
further including the classifier, after fitting, applying thresholds to the weighted sums to accomplish the distinguishing between holding and trading and the distinguishing between buying or selling.

14. The tangible non-transitory computer readable storage media of claim 10, wherein the questionnaire-based measures are collected using an adaptive questionnaire that selects questions to pose, after one or more opening questions in a category, based at least in part on responses to previous questions in the category.

15. The tangible non-transitory computer readable storage media of claim 10,
wherein the questionnaire-based measures score individual questions in the categories;
inputting the questionnaire-based measures and demographic data to one or more convolutional neural network (abbreviated CNN) classifiers; and
further including the CNN classifiers outputting data to a layer that classifies the subject as holding or trading, and further classifies the trading subject as buying or selling.

16. The tangible non-transitory computer readable storage media of claim 15, further including using an ensemble of CNN classifiers with separate CNNs organized to process respective categories of the questionnaire-based measures; and
the separate CNNs outputting data to the layer that classifies the subject as buy, sell or hold.

17. A computer-implemented method for building a prediction classifier for individual subject trading behavior in response to a past or future hypothetical market event, utilizing questionnaire-based measures of at least attitude towards risk (abbreviated ATR) and confidence, including executing on a processor the program instructions from the non-transitory computer readable storage media of claim 1, to implement the accessing, classifying, fitting and storing.

18. A computer-implemented method for alerting an advisor to predicted trading behavior of a subject responsive to a past or future hypothetical market event, including executing on a processor the program instructions from the tangible non-transitory computer readable storage media of claim 10, to implement the inputting, applying and generating.

19. A system for building a prediction classifier for individual subject trading behavior in response to a past or future hypothetical market event, utilizing questionnaire-based measures of at least attitude towards risk (abbreviated ATR) and confidence, the system including a processor, memory coupled to the processor, and computer instructions from the non-transitory computer readable storage media of claim 1 loaded into the memory.

20. A system for alerting an advisor to predicted trading behavior of a subject responsive to a past or future hypothetical market event includes one or more processors coupled to memory, the memory loaded with computer instructions, that when executed on the processors, implement the inputting, applying and generating of claim 10.
